(19) United States
(12) Patent Application Publication
(10) Pub. No.: US 2003/0065869 A1
(43) Pub. Date: Apr. 3, 2003

(54) PCI/LVDS half bridge

(76) Inventors: Francois Balay, Aschheim (DE); Peter Riedl, Dauchau (DE)

Correspondence Address: MANELLI DENISON & SELTER PLLC, 7th Floor, 2000 M Street, N.W., Washington, DC, 20036-3307, US

(21) Appl. No.: 09/966,095

(22) Filed: Oct. 1, 2001

(51) Int. Cl. G06F 13/36

(52) U.S. Cl. 710/314

(57) ABSTRACT

A system and method for providing communication between two computer bus segments. Two half-bridge circuits are connected to respective computer bus segments and frame data for a high speed transfer of the data between the half-bridge circuits. A common application is to connect multiple PCI segments that are individually limited to the number of components connected thereto. Connection through the high speed half-bridge circuits allows additional PCI components to communicate on a second computer bus segment, acting as an expansion bus.

### BACKGROUND OF THE INVENTION

1. Field of the Invention

This invention relates generally to a high speed structure and method for the transfer of information from a first backplane structure to second backplane structure. More particularly, it relates to a system and method for a high speed structure and method for the transfer of information from a first PCI bus to a second PCI bus.

2. Background of Related Art

Compact PCI (Peripheral Component Interconnect) has become a standard implementation for many telecommunications systems which provides a well-standardized backplane structure. In addition, a large variety of solutions ensure vendor independence and low cost, as solutions are widely available (e.g., PLX chips, FPGA with PCI core, FPSCs, etc.).

With PCI, different line cards or blades of a system are connected with a PCI bus structure. As with any bus structure, the number of line cards that can be connected on a single PCI bus is limited. Typically five line cards are supported on a 33 MHz PCI bus structure. For larger systems, multiple independent PCI segments have to be implemented, each supporting a limited number of elements.

Bandwidth requirements in telecommunications systems are rapidly increasing requiring the use of PCI's fastest 66 MHz specification, which further increases the number of segments required in complex system.

The transfer of data information between backplane architectures is becoming more common in modern computer systems because of the need of multitudes of line cards such as modems, network cards, high speed serial cards, etc.

FIG. 3 illustrates the typical way to interconnect multiple PCI segments together, using dedicated hardware consisting of multiple PCI to PCI bridges.

In particular, as shown in FIG. 3, first PCI segment PCI1 is connected to a second PCI segment PCI2 through a conventional PCI to PCI bridge 1. PCI segment PCI 2 has, for example, attached to it two line cards LC1 and LC2. PCI segment PCI1 is also attached to a second PCI segment PCI3 through a second conventional PCI to PCI bridge 2. The second PCI segment PCI3 has, for example attached to it two line cards LC3 and LC4.

In operation, data information on PCI segment PCI1 passes through PCI to PCI bridge 1 and PCI segment PCI2 to reach lines cards LC1 and LC2, and vise versa. PCI to PCI bridge 1 operates at the same clock frequency as the PCI segmetns, PCI1 and PCI2, it bridges. Again, data information on PCI segment PCI1 passes through PCI to PCI bridge 2 to PCI segment PCI3 to reach line cards LC3 and LC4, and vise versa. PCI to PCI bridge 2, again, operates at the same clock frequency as the PCI segments, PCI1 and PCI3 it bridges.

As multiple elements are connected on each PCI bus, an arbitration phase is involved to determine which element is allowed to transfer data information. When a first PCI segment PCI1 transfers data information to another PCI segment, PCI2 or PCI3, PCI bridge 1 or PCI bridge 2 receive a transfer request from the first PCI segment PCI1. The PCI bridges 1 and 2 generate a transfer request on the PCI segment the first PCI segment PCI1 wishes to transfer data to or from. PCI segment, PCI2 or PCI3, will grant the transfer request to PCI segment PCI1 when there is available bandwidth on its segment for the transfer of data information.

The time needed for the arbitration process is not deterministic. The time between a transfer request and a transfer grant is uncertain and can vary from one transaction to another. Also, as multiple bridges must be crossed, the latency and latency variation increases. In telecom applications, the latency and latency variation from one data information transfer to another can become unacceptable. To guarantee quality of service in an ATM (Asynchronous Transfer Mode) Telecom system, a strict control of the latency variation is required.

A disadvantage of a conventional bridged implementation using multiple PCI to PCI bridges is that it is complex to set up and requires significant system overhead for configuration and management.

Another disadvantage of connecting multiple PCI to PCI buses using conventional bridges is that the distance between buses is limited by unacceptable capacitive loads.

A third example of a disadvantage of using a conventional PCI bridge is that the implementation of additional PCI segments for bridging purposes set constraints on the number of signals that have to be routed on a physically constrained backplane. These limit, for example, the datapath width of the PCI segments and make the backplane design complex and more expensive, as parasitic coupling, between two superposed high-speed buses, such as PCI, have to be minimized, requiring a strict control of the backplane layout.

Accordingly there exists a need for an apparatus and method for the transfer of data information between PCI segments that is no encumbered by the limitations as described above.

### SUMMARY OF THE INVENTION

In accordance with the principles of the present invention, a system for interconnecting two or more computer bus architectures is disclosed. A first bus segment transmits data information. A first half bridge circuit connects to the first bus segment. A second bus segment transmits data information. A second half bridge circuit connected to the first half bridge circuit and the second bus segment transfers data information between the first half bridge circuit and the second bus segment.

A method of interconnecting two or more computer bus architectures in accordance with yet another aspect of the present invention comprises connecting a first half bridge circuit to a first bus segment. The first half bridge circuit is connected to a second bus segment and data information from the first half bridge circuit is transmitted over the second bus segment.

An apparatus for interconnecting two or more computer bus architectures in accordance with yet another aspect of the present invention comprises a first half bridge circuit connected to a first bus segment. A second half bridge circuit is connected to a second bus segment and the second bus segment transmits data information from a first half bridge circuit over a second bus segment.

### BRIEF DESCRIPTION OF THE DRAWINGS

Features and advantages of the present invention will become apparent to those skilled in the art from the following description with reference to the drawings, in which:

FIG. 1 shows an embodiment of the invention using two half bridges to interconnect two PCI segments.

FIG. 2 shows a more detailed view of either of the half bridge circuits of FIG. 1 used to implement the preferred embodiments of the invention.

FIG. 3 shows a conventional interconnection of PCI segments using PCI to PCI bridges.

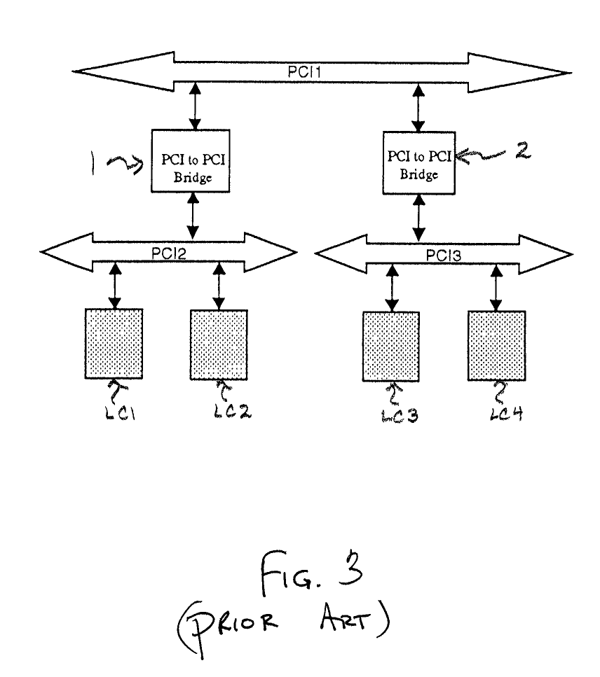

### DETAILED DESCRIPTION OF ILLUSTRATIVE EMBODIMENTS

The present invention provides a method and apparatus for connecting multiple computer bus architectures using high speed interfaces. In particular, the present invention provides a method and apparatus for connecting multiple PCI segments using high speed PCI/LVDS half bridge circuits.

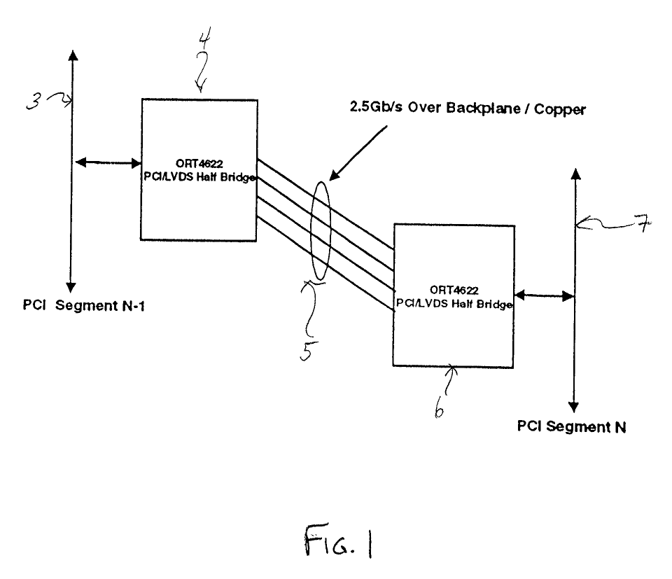

FIG. 1 shows an embodiment in accordance with the principles of the present invention utilizing two half bridge circuits to connect to PCI segments.

In particular, as shown in FIG. 1 a first PCI bus segment 3 and a second PCI bus segment 7 are connected by a high speed interface. The high speed interface is comprised of a first half bridge circuit 4 and a second half bridge circuit 6. Between the first half bridge circuit 4 and the second half bridge circuit 6 is a high speed serial connection 5.

In operation, the first PCI bus segment 3 would have attached to it one or more line cards, not shown for simplicity but the same as in the prior art, in communication with each other or a computer system. Once the line cards or the computer system needs to communicate with other components not attached to its local PCI bus segment 3, the computer system or line cards send an access request to remote components along with data information, if data information is being sent to a remote component.

An access request is taken in by the first half bridge circuit 4 and passed to the second half bridge circuit 6, along with data if data information is being sent to a remote component. The second half bridge circuit 6 takes in the request and possible data information and monitors the second PCI bus segment 7 for access thereto. Once PCI bus segment 7 has available bandwidth to accept the access request, data information is routed to the appropriate components attached to PCI bus segment 7.

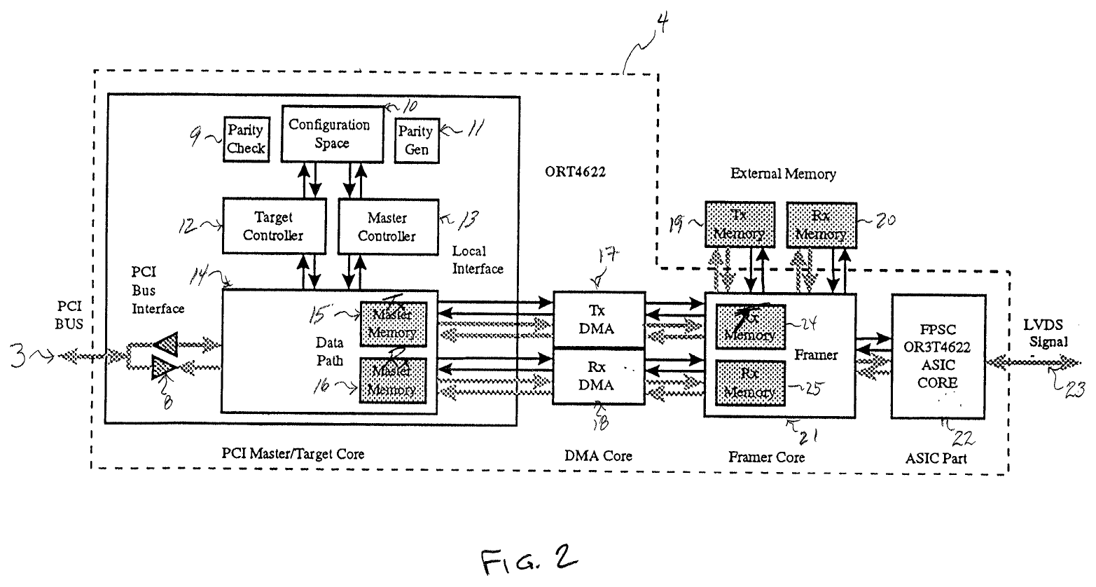

FIG. 2 shows a detailed description of the components making up the half bridge circuit shown in FIG. 1.

As shown in FIG. 2, the first half bridge circuit 4 is connected with the second half bridge circuit 6 by four full duplex high speed serial data lines 5 each having a bandwidth of 622 Mb/s. The four full duplex high speed serial lines 5 would a total data bandwidth of 2.5 Gb/s.

Depending on the bandwidth needed for the particular application, more or less high speed full duplex serial lines could be used to arrive at the desired bandwidth. Also, parallel data lines could be used to transfer information between the first half bridge circuit 3 and the second half bridge circuit 7. Parallel data lines would require a greater area on the backplane for routing.

The above description of an access request originating from the first PCI bus segment 3 for access to the second PCI bus segment 7 is representative of access requests originating from either the first PCI bus segment 3 or the second PCI bus segment 7. Information is passed bi-directionally throughout the system.

The first and second half bridge circuits, 4 and 6, would consist of an ORT4622 Lucent FPSC (Field Programmable System Chip) which implements a 2.5 Gb/s physical (LVDS Serial I/Os with clock recovery) and transport layers together with a PCI controller. Although the ORT4622 is shown, any number of components supporting high speed data transfer between bus segments could be used to implement the invention.

FIG. 2 shows a detailed makeup of either of the half bridge circuits, 4 or 6, from FIG. 1. Although FIG. 2 represents either half bridge circuits 3 or 6 from FIG. 1, the following description will describe half bridge circuit 4.

The half bridge circuit 4 is comprised of a PCI bus interface 8 connecting the half bridge circuit 4 to the PCI bus 3. The PCI bus interface 8 is connected to the data path 14. Data path 14 is the central hub of the half bridge where all signals pass. Data path 14 is connected to target controller 12, which is in turn connected to configuration space 10. Configuration space 10 connects to both a parity check circuit 9 and parity generator circuit 11. Configuration space 10 connects to master controller 13, which is connected to data path 14. Data path 14 contains two master memories, 15 and 16, for respective transmission and reception of data.

Connected to data path 14 is a transmit DMA (Direct Memory Access) channel 17 and a reception DMA channel 16. The transmit DMA channel 17 is connected to framers 21 transmit memory 24. The reception DMA channel 18 is connected to framer's 21 reception memory 25. Framer is connected to additional transmit memory 19 and reception memory 20. Framer 21 is further connected to FPSC OR3T4622 ASIC core 22 which produces the half bridge's 4 LVDS I/O 23.

First, the operation of the half bridge 4 will be discussed when a master requests access to a target, with data moving from the PCI bus segment 3 to the LVDS I/O 23.

An access request enters the half bridge 4 from PCI segment 3 through the PCI bus interface 8. The request is received by the data path circuit 14. Target controller 12 contains a base address register that controls the internal DMA and to read/write data directly into master memories 15 and 16. A parity check is first performed by parity check circuit 9 to verify the integrity of the access request data. Once the integrity of the access request is verified, the target controller appends the access request data with configuration data stored in the configuration space 10 to create a modified access request. Configuration space is made up of an FPGA that is programmed with particular configuration data for the application the half bridge circuit is intended for.

From configuration space 10, a new parity value is generated by the parity generator 11 and appended to the modified access request signal. The modified access request signal is buffered in Tx master memory 15 for transmission. Tx DMA circuit directly accesses master memory 15 for the transfer the modified access request signal into framer 21 Tx memory 24. Framer 21 buffers access requests in internal memory Tx memory 24 until there is an appropriate amount of data to create a framed LVDS signal for transmission across LVDS I/O 23.

External memory Tx memory 19 is optional to the invention. Tx memory 19 adds additional storage capability to supplement the storage capability of the framer's Tx memory 24. To allow framer 21 to create larger framed data segments, the framer's Tx memory 24 is first filled, and subsequently, external Tx memory 19 is used to supplement the storage capability of the internal memory of framer 21.

In addition to adding capacity to supplement the storage capability of the framer's internal memories 24 and 25, external memories 19 and 20 buffer data for data rate adaptation. A PCI bus conventionally operates at 33 and 66 Mhz. The ASIC core 22 operates at approximately 78 Mhz. The data passing through framer 21 is buffered to allow the transfer of data between circuits operating at different frequencies.

The framer 21 takes the modified access request signals from the Tx memory 24 and packets the data into a frame suitable for transmission in LVDS form. Overhead data allowing the opposite half bridge circuit is attached to the frame allowing the opposite half bridge circuit to decode the frame back into its modified access requests.

Framer 21 then pass the framed modified access requests to a Lucent FPSC (Field Programmable System Chip) OR3T4622 ASIC CORE circuit 22. FPSC OR3T4622 ASIC CORE 22 combines field-programmable logic with ASIC or mask programmable logic on a single chip to create a circuit that is configurable. The FPSC OR3T4622 ASIC CORE 22 is configured to efficiently convert the framed signal into a serial LVDS which is placed on the LVDS I/O 23 signal path.

A half bridge circuit identical to half bridge circuit 4 shown in FIG. 2 receives the LVDS signal and decodes the signal for placement on a PCI bus segment. Receipt of an LVDS signal by a half bridge circuit according to the invention will now be described. FIG. 2 will also be used to describe the operation of a half bridge circuit when receiving an LVDS signal.

The LVDS I/O 23 receives the LVDS signal and passes the signal to the FPSC OR3T4622 ASIC CORE 22. The FPSC OR3T4622 ASIC CORE 22 takes the signal and converts the serial bit stream to a parallel data stream. The parallel data stream is passed to the framer 21 for processing.

Framer 21 buffers the parallel data stream received from FPSC OR3T4622 ASIC CORE 22 in external memory Rx memory 20 until an entire frame is received. Once an entire frame of data is received, framer 21 decodes the frame by according to the frame header attached to the frame of data received. The decoded frame then placed in the framer Rx memory 25 for transmission of the received data to master memory 16. Rx DMA performs a direct memory transfer of the data in framer Rx memory 25 to data path Rx memory 16.

Data path 14 passes the signal from the Rx memory 16 to master controller where the data signal is parity check by parity check circuit 9. Upon verification of data integrity, master controller 13 performing as dictated by previously stored configuration data in configuration space 10, interfaces with the master on the PCI bus segment attached to the PCI bus interface 8.

Although the present invention is described with reference to embodiments of a high speed interface between two PCI bus segments, the principles of the present invention are equally applicable to the bus protocols, i.e. SCSI (Small Computer Systems Interface), VLB (Visa Local Bus), AGP (Advanced Graphics Port), etc.

Although the present invention is described with reference to embodiments teaching four high speed serial data lines running between two half bridge circuits, the principles of the present invention are equally applicable to the addition or subtraction of high speed serial data lines depending upon the bandwidth needed between two half bridge circuits.

While the invention has been described with reference to the exemplary embodiments thereof, those skilled in the art will be able to make various modifications to the described embodiments of the invention without departing from the true spirit and scope of the invention.

What is claimed is:

1. A system for interconnecting two or more computer bus architectures, comprising:
a first bus segment to transmit data information;
a first half bridge circuit connected to said first bus segment;
a second bus segment to transmit data information;
a second half bridge circuit connected to said first half bridge circuit and said second bus segment for transferring data information between said first half bridge circuit and said second bus segment.

2. The system for interconnecting two or more computer bus architectures according to claim 1, wherein:
said first bus segment is a PCI architecture bus.

3. The system for interconnecting two or more computer bus architectures according to claim 1, wherein:
said second bus segment is a PCI architecture bus.

4. The system for interconnecting two or more computer bus architectures according to claim 1, wherein:
said first half bridge segment and said second half bridge segment communicate with a high speed serial bus protocol.

5. The system for interconnecting two or more computer bus architectures according to claim 1, wherein:
said first bus segment operates at a different bus frequency than a bus frequency of said second bus segment.

6. The system for interconnecting two or more computer bus architectures according to claim 1, wherein:
said first bus segment operates at a substantially same bus frequency as a bus frequency of said second bus segment.

7. The system for interconnecting two or more computer bus architectures according to claim 1, wherein:
at least one of said first half bridge circuit and said second half bridge circuit are field programmable.

8. The system for interconnecting two or more computer bus architectures according to claim 1, wherein:
said first half bridge circuit and said second half bridge circuit recover a clock signal from, respectively said first bus segment and said second bus segment.

9. The system for interconnecting two or more computer bus architectures according to claim 4, wherein:
said high speed serial bus protocol is full duplex.

10. A method of interconnecting two or more computer bus architectures comprising:
connecting a first half bridge circuit to a first bus segment;
connecting said first half bridge circuit to a second bus segment; and
transmitting data information from said first half bridge circuit over said second bus segment.

11. A method for interconnecting two or more computer bus architectures according to claim 10, wherein:
said step of transmitting data transmits data over a PCI architecture bus.

12. A method for interconnecting two or more computer bus architectures according to claim 10, wherein:
said step of transmitting data transmits data over a PCI architecture bus.

13. A method for interconnecting two or more computer bus architectures according to claim 10, wherein:
communication over said first half bridge segment and said second half bridge segment occurs with a high speed serial bus protocol.

14. A method for interconnecting two or more computer bus architectures according to claim 10, wherein:
operation of a bus frequency of said first bus segment is different than a bus frequency of said second bus segment.

15. A method for interconnecting two or more computer bus architectures according to claim 10, wherein:
operation of a bus frequency of said first bus segment is substantially the same as a bus frequency of said second bus segment.

16. A method for interconnecting two or more computer bus architectures according to claim 10, further comprising:
field programming at least one of said first half bridge circuit and said second half bridge circuit.

17. A method for interconnecting two or more computer bus architectures according to claim 10, further comprising:
recovering a clock signal for said first half bridge circuit and said second half bridge circuit from their respectively connected said first bus segment and said second bus segment.

18. A method for interconnecting two or more computer bus architectures according to claim 13, wherein:
full duplexing said high speed serial bus.

19. A system for interconnecting two or more computer bus architectures comprising:
a first half bridge circuit means connected to a first bus segment means;
a second half bridge circuit means connected to a second bus segment means; and
a second bus segment means transmitting data information from said first half bridge circuit over said second bus segment.

20. The system for interconnecting two or more computer bus architectures according to claim 19, wherein:
said first bus segment is a PCI architecture bus.

21. The system for interconnecting two or more computer bus architectures according to claim 19, wherein:
said second bus segment means is a PCI architecture bus.

22. The system for interconnecting two or more computer bus architectures according to claim 19, wherein:
said first half bridge segment means and said second half bridge segment means communicate with a high speed serial bus protocol.

23. The system for interconnecting two or more computer bus architectures according to claim 19, wherein:
said first bus segment means bus frequency is different than said second bus segment means bus frequency.

24. The system for interconnecting two or more computer bus architectures according to claim 19, wherein:
said first bus segment means bus frequency is the same as said second bus segment means bus frequency.

25. The system for interconnecting two or more computer bus architectures according to claim 19, further comprising:
at least one of said first half bridge circuit means and said second half bridge circuit means are field programmable.

25. The system for interconnecting two or more computer bus architectures according to claim 19, further comprising:
said first half bridge circuit means and said second half bridge circuit means recover a clock signal from their respectively connected said first bus segment means and said second bus segment means.

26. The system for interconnecting two or more computer bus architectures according to claim 23, wherein:
said high speed serial bus protocol is full duplex.
